(19) United States
(12) Patent Application Publication
(10) Pub. No.: US 2002/0187233 A1
(43) Pub. Date: Dec. 12, 2002

(54) Composition that eliminates the aftertaste of non-nutritive sweeteners and stabilize flavorings used with non-nutritive sweeteners and methods related thereto

(76) Inventors: Morris Mann, Glendale, AZ (US); Cheryl R. Mitchell, Stockton, CA (US)

Correspondence Address: The Halvorson Law Firm, Ste 1, 405 W. Southern Ave., Tempe, AZ, 85282, US

(21) Appl. No.: 10/166,587

(22) Filed: Jun. 5, 2002

Related U.S. Application Data
(60) Provisional application No. 60/296,903, filed on Jun. 11, 2001.

(51) Int. Cl. A23L 1/236

(52) U.S. Cl. 426/548

(57) ABSTRACT

Described are methods and compositions that eliminate the aftertaste of the various non-nutritive sweeteners. These include, but are not limited to, sucralose, aspartame and acesulfame-k (also known as the potassium salt of ascesulfame). In addition, methods and compositions are described which allow for stability of various flavoring compositions used in conjunction with non-nutritive sweeteners.

This application is a continuation of pending provisional application Ser. No. 60/296,903 filed on Jun. 11, 2001.

### FIELD OF THE INVENTION

The present invention relates generally to the field of non-nutritive sweetener compositions and compositions that eliminate the aftertaste associated with said non-nutritive sweeteners. In addition, the invention as described also allows for enhanced stability of flavoring compositions used in conjunction with non-nutritive sweeteners.

### DESCRIPTION OF THE BACKGROUND ART

The three most commonly used non-nutritive sweeteners at the present time are aspartame, the potassium salt of acesulfame, and sucralose, see FIGS. 1-3. Whereas aspartame is unstable and heat sensitive, the other two, sucralose and acesulfame are not. In fact, both acesulfame and sucralose can be used in products that require baking or cooking for extended periods of time. However, the vast majority of non-nutritive sweetener use is in the beverage industry.

Aspartame is a non-nutritive sweetener that is one hundred and sixty (160) times sweeter than sucrose. Because of its sweetness intensity, it is utilized in beverage systems at levels of between 5 mg % and 200 mg % by weight as a replacement for sucrose or other nutritive carbohydrates to produce a low sugar/low calorie product. Three fourths of all aspartame sales are made to the diet beverage industry.

The potassium salt of acesulfame or acesulfame-k is one hundred and eighty (180) times sweeter than sucrose. It is also used at levels of between 5 mg % and 200 mg % by weight as a replacement for sucrose or other nutritive carbohydrates to produce a low sugar/low calorie product. Eighty percent (80%) of all sales of acesulfame-k are to the beverage industry.

Both acesulfame-k and aspartame have a disagreeable lingering aftertaste that is frequently described as metallic or bitter. Those people who detect an aftertaste with aspartame and acesulfame-k are less likely to consume beverages sweetened with these compositions because of their negative flavor profile. Therefore, a composition that would reduce these negative characteristics would significantly impact the aforementioned consumers who find non-nutritive sweeteners such as acesulfame-k and aspartame to be disagreeable. Obviously, there exists a need in the art for such compositions and methods.

Sucralose is a non-nutritive sweetener that is six hundred times (600) sweeter than sucrose. It represents a chloro-halogentated sucrose molecule that has the novel property of stability at temperatures that are commonly used in cooking and baking. Currently, seventy percent (70%) of all sucralose is used in the beverage industry. Sucralose has been described as having a peculiar sweet aftertaste that may last for as long as forty-five minutes after its initial ingestion. This is considered by many consumers to be an extremely negative property. Clearly, a composition that could eliminate the aftertaste associated with sucralose would represent a significant advance in the development of products containing sucralose as a non-nutritive sweetening composition.

Aspartame and various flavored compositions are known to have very negative influences on one another. In particular, it has been noticed that flavor compositions containing ketones are particularly susceptible to degradation in the presence of aspartame. Concomitantly, it is known that said flavoring compositions greatly diminish the sweetness associated with aspartame in a very short period of time. Therefore, a number of flavoring agents are not usable with aspartame as a result of this particular reaction to reduce the negative aftertaste. Therefore, there exists a need in the art for a method and composition that will enhance the stability of said flavorings in conjunction with aspartame and other non-nutritive sweeteners. In addition, there exists a significant need in the art for compositions and methods that would allow non-nutritive sweeteners to be used in baked or cooked goods without the lingering aftertaste that is currently associated with said products at the present time.

Since the introduction of non-nutritive sweeteners, many researchers have attempted to reduce the aftertaste using a variety of substances with very limited success. One example is described in U.S. Pat. No. 4,690,827 to Kupper, et al. This patent discloses a process for increasing pulp volume (pulp composed of either homogenized fruit pulp, cellulose, or a cellulose/pectin material) in artificially sweetened beverages containing fruit juices. It was found that the increased pulp volume of reduced size objectively decreased the aftertaste of a variety of non-nutritive sweeteners. These included aspartame, saccharin, and cyclamate non-nutritive sweeteners. The mechanism by which the aftertaste of these artificial sweeteners was diminished was not discussed. However, the importance of increased pulp volume and decreased fruit pulp particle size was determined to be important in the effect noted. This increased pulp volume apparently had the same effect on all of the non-nutritive sweeteners mentioned.

Clearly there exists a need in the art for compositions and methods that will eradicate the lingering aftertaste associated with the various non-nutritive sweeteners. Particularly, there is a need for compounds that are generally regarded as safe and can be used in said food products. Equally important would be compositions and methods that would be useful for eliminating the aftertaste associated with non-nutritive sweeteners that would not be effected by cooking or baking and would not alter viscosity.

### SUMMARY OF THE INVENTION

The present invention involves a novel sweetener composition comprising a food starch-modified syrup and/or food starch-modified syrup solids (herein the abbreviation “FSMS” shall mean food starch-modified syrup and/or food starch-modified syrup solids), a non-nutritive sweetener, and optionally the addition of various mineral compositions of varying concentrations depending upon the non-nutritive sweetener employed, and the use of the sweetener composition according to the present invention to sweeten food and beverage products.

Development of the FSMS involves basic starch modification processes in conjunction with an anhydrous acid composition, followed by enzymatic hydrolysis. The FSMS resulting from this technology can be derived from a variety of different grains. These include but are not limited to rice, wheat, corn, potato and the like. The preferred grain for this invention is rice, and therefore starches derived from rice would be considered optimal in this particular invention.

Empirical evidence developed in the process of testing the composition according to the present invention has shown that for aspartame and sucralose a simple ratio of the FSMS on a dry basis in conjunction with the aforementioned non-nutritive sweeteners is sufficient to generate a favorable result. In the case of aspartame, a ratio of 3.5:1 is optimal. However, for different purposes and different food substrates, a ratio that goes as high as four parts of the FSMS on a dry basis in conjunction with one part of aspartame may prove to be superior. This is particularly true when larger quantities of aspartame need to be used in non-beverage substances.

Sucralose requires the addition of the FSMS on a dry basis at a ratio of three parts of the composition to one part of sucralose and in certain instances up to five parts of FSMS on a dry basis in conjunction with one part of sucralose. Clearly, other ratios may indeed be used in conjunction with compositions that contain different flavoring compositions. However, ratio changes do not alter the spirit or effect of the invention.

Acesulfame-K, cyclamate, and saccharin represent non-nutritive sweeteners that contain sulfur. Other non-nutritive sweeteners containing sulfur will also be affected by the composition that will be described. Unlike aspartame and sucralose, acesulfame-k, saccharin, and cyclamate require the addition of certain minerals in conjunction with the FSMS as well as certain amino acids. These minerals include but are not limited to salts of manganese, copper, and zinc, calcium, magnesium, and boron. These salts may be a variety of different forms. These include but are not limited to chloride, phosphate, gluconate, carbonate, picolinate, citrate, malate salts, and/or other like salts. For the purpose of this invention, the gluconate, citrate, and picolinate salts represent the preferred embodiment.

Concomitantly it was found that the addition of the FSMS in conjunction with flavors that were high in ketones resulted in a stability that would not have been expected by one skilled in the art, especially in association with aspartame. Equally surprising, was the fact that the stability extended not only to the flavoring composition but also to the associated sweetness of aspartame over time.

The novel features that are considered characteristic of the invention are set forth with particularity in the appended claims. The invention itself, however, both as to its structure and its operation together with the additional objects and advantages thereof will best be understood from the following description of the preferred embodiment of the present invention when read in conjunction with the accompanying figures. Unless specifically noted, it is intended that the words and phrases in the specification and claims be given the ordinary and accustomed meaning to those of ordinary skill in the applicable art or arts. If any other meaning is intended, the specification will specifically state that a special meaning is being applied to a word or phrase. Likewise, the use of the words “function” or “means” in the Description of Preferred Embodiments is not intended to indicate a desire to invoke the special provision of 35 U.S.C. §112, paragraph 6 to define the invention. To the contrary, if the provisions of 35 U.S.C. §112, paragraph 6, are sought to be invoked to define the invention(s), the claims will specifically state the phrases “means for” or “step for” and a function, without also reciting in such phrases any structure, material, or act in support of the function. Even when the claims recite a “means for” or “step for” performing a function, if they also recite any structure, material or acts in support of that means of step, then the intention is not to invoke the provisions of 35 U.S.C. §112, paragraph 6. Moreover, even if the provisions of 35 U.S.C. §112, paragraph 6, are invoked to define the inventions, it is intended that the inventions not be limited only to the specific structure, material or acts that are described in the preferred embodiments, but in addition, include any and all structures, materials or acts that perform the claimed function, along with any and all known or later-developed equivalent structures, materials or acts for performing the claimed function.

### DESCRIPTION OF THE DRAWINGS

FIG. 1 is an illustration of the structure of aspartame.

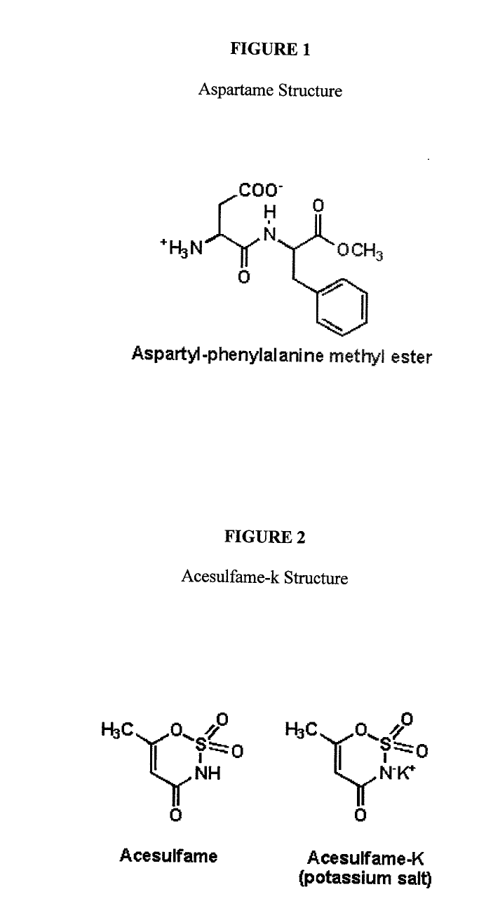

FIG. 2 is an illustration of the structure of acesulfame-k.

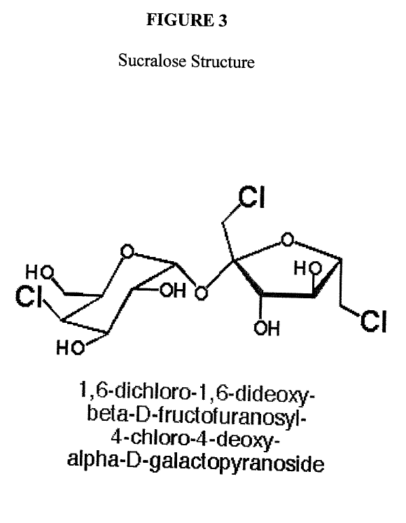

FIG. 3 is an illustration of the structure of sucralose.

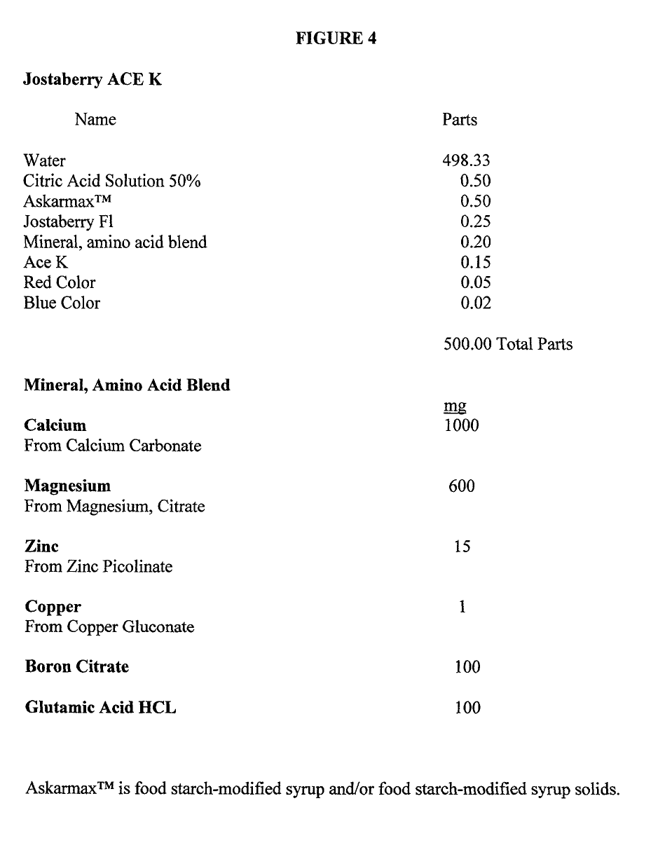

FIG. 4 is an embodiment of a preferred formulation according to the present invention.

FIG. 5 is another embodiment of a preferred formulation according to the present invention.

### DETAILED DESCRIPTION OF THE INVENTION

Acesulfame-K (ASK), cyclamates, saccharin and other sulfur containing non-nutritive sweeteners have been particularly challenging in terms of aftertaste. Fully 50% of any given population has a predisposition to notice an unpleasant bitter metallic aftertaste associated with the attendant sweetness. As such, the utility of these compositions has been problematic. Surprisingly, however, a modified hydrolyzed rice starch in conjunction with certain minerals and amino acids has proven extremely useful in greatly diminishing this aftertaste. In fact, when used in conjunction with appropriate flavoring technology, the inventive composition effectively eliminates negative aftertaste. Mineral salts, which may or may not be organic, are particularly useful in this invention.

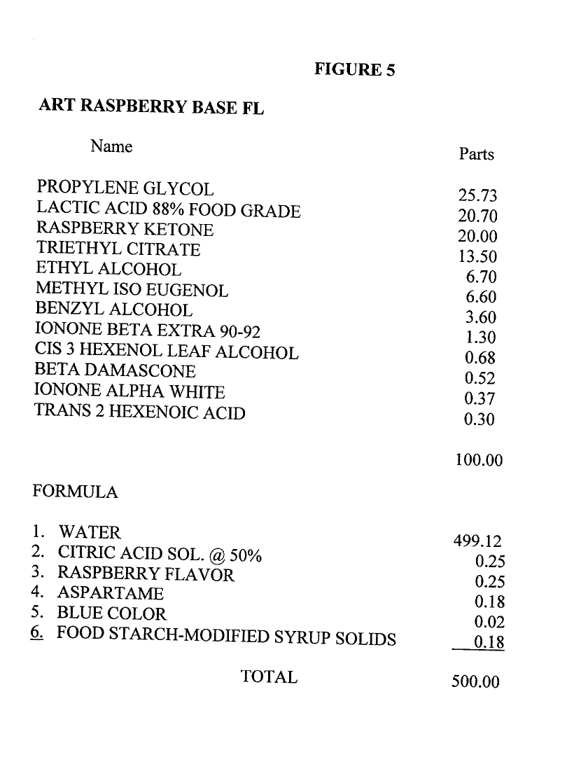

The preferred formulation as it relates to the aforementioned non-nutritive sweeteners is noted in FIG. 4. As used herein the term starch means a white odorless, tasteless, glucose based complex carbohydrate with the general formula (C₆H₁₀O₅)ₓ that is the chief storage form of carbohydrate in plants. Many mineral salts have proven useful with the FSMS. They have been useful either separately, or blended with one another. They include but are not limited to picolinate, citrate, gluconate, chloride, carbonate, malate, phosphate, chelidamate, magnesium, calcium, boron, manganese, chromium, copper and/or zinc salts. The amino acid glutamate in a variety of water-soluble salts is also useful in conjunction with the mineral salts noted to optimize the requisite effect of diminishing the aftertaste noted with these non-nutritive sweeteners.

Since the non-nutritive sweeteners are stable in a variety of processing temperatures, it should be noted that the invention as described is capable of significantly extending their utility in a variety of foods including cooked and baked nutrients for which a low carbohydrate content is desired, as well as beverages that require aseptic processing or pasteurization. It should also be noted that compositions comprising the present invention and these particular non-nutritive sweeteners is stable at pHs ranging from 2-11.

Note, in the formulation described in FIG. 4 that the ratio of FSMS on a dry basis to ASK is 3:1. The ratio range for efficacy in cyclamate and saccharin is the same, but depending on the flavoring and substrate; i.e., liquid or solid, said ratio may range from 0.5:1 to 6:1 or more. The ratio between the FSMS on a dry basis and the mineral complex as noted in FIG. 4 is optimally 5:2 but may range from 0.5:10 to 10:1 depending on the flavors and substrates in which these compositions are used.

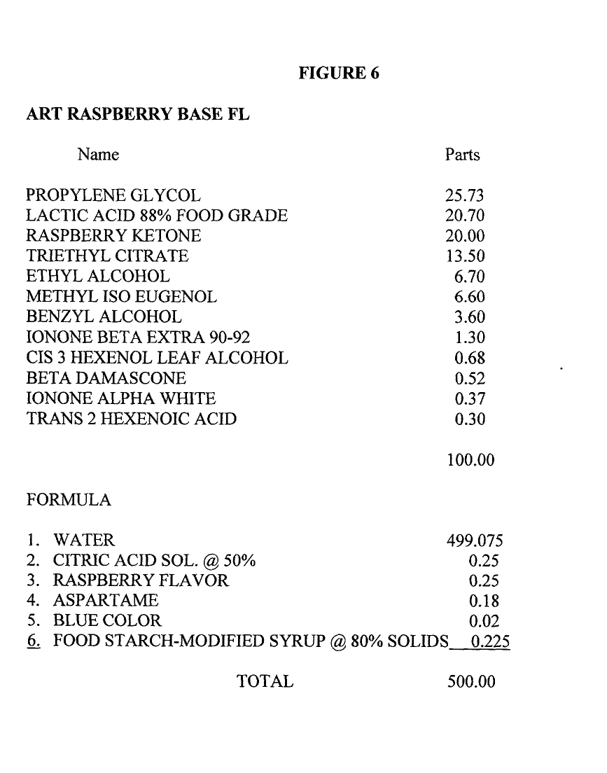

Aspartame is the most common non-nutritive sweetener used in beverages. It presents particular challenges because of its instability and its apparent ability to degrade certain flavor compositions. Therefore, surprisingly, it has been found that the FSMS as a single entity eliminates the aftertaste associated with aspartame and enhances the stability of aspartame's sweetness in conjunction with flavors that would otherwise rapidly degrade. Representative flavorings are noted in FIGS. 5 and 6. Its use profile in conjunction with aspartame and the FSMS on a dry basis is 1:1. However, depending on the flavoring composition and the substrate in which it is embodied, the ratio may be 0.2:1 up to 3:1. Changing the ratio outside these parameters does not change the spirit or nature of the invention as should be clearly apparent to one skilled in the art.

Sucralose, which is bi-chloro halogenated sucrose, is 600 times sweeter than sucrose. Because of its unique molecular structure, it is recognized as being profoundly sweet with a lingering sweet aftertaste that is very unpleasant. However, using the FSMS, this problem is surprisingly eliminated. Because of the heat stability of sucralose, this particular non-nutritive sweetener is useful in a wide variety of products from beverages to baked goods wherein it is desirable to have low levels by weight of simple sugars. Depending on the substrate and flavoring composition, the ratio of the FSMS on a dry basis to sweetener will range from 0.5:1 to 6:1. Clearly, alterations of this ratio by one skilled in the art does not alter the spirit or novelty of the invention.

The FSMS used in the present invention is available from Creative Research Management, Inc. located in Stockton, Calif. The non-nutritive sweeteners are available from Sigma-Aldrich, St. Louis Mo. and others well known manufacturers. The flavor ingredients are available from Melcher's Inc. in Fairfield, Ohio and others.

The FSMS is a composition comprising a food starch modified with an anhydrous acid followed by enzymatic hydrolysis, a non-nutritive sweetener, and optionally the addition of various mineral compositions of varying concentrations depending upon the non-nutritive sweetener employed.

The preferred embodiment of the invention is described above in the Figures and Description of Preferred Embodiments. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s). The foregoing description of a preferred embodiment and best mode of the invention known to the applicant at the time of filing the application has been presented and is intended for the purposes of illustration and description. It is not intended to be exhaustive or to limit the invention to the precise form disclosed, and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated.

What is claimed is:

1. A composition for reducing negative aftertaste of non-nutritive sweeteners comprising a food starch-modified syrup and/or food starch-modified syrup solids.

2. The composition according to claim 1 wherein the starch is derived from rice, wheat, corn, or potato.

3. The composition according to claim 1 wherein the starch is derived from rice.

4. The composition according to claim 1 further comprising a non-nutritive sweetener, said composition have the food starch-modified syrup and/or food starch-modified syrup solids on a dry basis to sweetener ratio ranging from 6:1 to 0.5:1.

5. The composition according to claim 4 wherein the sweetener is aspartame and the ratio is generally 3.5:1.

6. The composition according to claim 4 wherein the sweetener is sucralose and the ratio is generally 3:1.

7. The composition according to claim 4 wherein the sweetener is sucralose and the ratio is generally 5:1.

8. The composition according to claim 4 wherein the sweetener is acesulfame-k and the composition further comprises additional mineral supplements

9. The composition according to claim 8 wherein the additional mineral supplements comprise picolinate, citrate, gluconate, glutamate, chloride, carbonate, malate, phosphate, chelidamate, magnesium, calcium, boron, manganese, chromium, copper and/or zinc salts.

10. The composition according to claim 8 wherein the additional mineral supplements are gluconate, picolinate, and citrate salts.

11. The composition according to claim 9 wherein the food starch-modified syrup and/or food starch-modified syrup solids on a dry basis to mineral additive composition ratio ranges from 0.5:10 to 10:1.

12. The composition according to claim 10 wherein the food starch-modified syrup and/or food starch-modified syrup solids on a dry basis to mineral additive composition ratio ranges from 0.5:10 to 10:1.

13. The composition according to claim 9 wherein the food starch-modified syrup and/or food starch-modified syrup solids on a dry basis to mineral additive composition ratio is generally 5:2.

14. The composition according to claim 10 wherein the food starch-modified syrup and/or food starch-modified syrup solids on a dry basis to mineral additive composition ratio is generally 5:2.

15. The composition according to claim 1 further stabilizing flavor compositions otherwise unstable in the presence of aspartame.

16. The composition according to claim 2 further stabilizing flavor compositions otherwise unstable in the presence of aspartame.

17. The composition according to claim 3 further stabilizing flavor compositions otherwise unstable in the presence of aspartame.

18. The composition according to claim 4 further stabilizing flavor compositions otherwise unstable in the presence of aspartame.

19. The composition according to claim 5 further stabilizing flavor compositions otherwise unstable in the presence of aspartame.

20. The composition according to claim 6 further stabilizing flavor compositions otherwise unstable in the presence of aspartame.

21. The composition according to claim 7 further stabilizing flavor compositions otherwise unstable in the presence of aspartame.

22. The composition according to claim 8 further stabilizing flavor compositions otherwise unstable in the presence of aspartame.

23. The composition according to claim 9 further stabilizing flavor compositions otherwise unstable in the presence of aspartame.

24. The composition according to claim 10 further stabilizing flavor compositions otherwise unstable in the presence of aspartame.

25. The composition according to claim 11 further stabilizing flavor compositions otherwise unstable in the presence of aspartame.

26. The composition according to claim 12 further stabilizing flavor compositions otherwise unstable in the presence of aspartame.

27. The composition according to claim 13 further stabilizing flavor compositions otherwise unstable in the presence of aspartame.

28. The composition according to claim 14 further stabilizing flavor compositions otherwise unstable in the presence of aspartame.
